(19) United States
(12) Patent Application Publication
(10) Pub. No.: US 2015/0089878 A1
(43) Pub. Date: Apr. 2, 2015

(54) GLASS RUN FOR AUTOMOBILE

(71) Applicant: TOYODA GOSEI CO., LTD., Kiyosu-shi (JP)

(72) Inventors: Hirofumi OTSUKA, Kiyosu-shi (JP); Kentaro ADACHI, Kiyosu-shi (JP); Masahiko ITO, Kiyosu-shi (JP)

(21) Appl. No.: 14/445,295

(22) Filed: Jul. 29, 2014

(30) Foreign Application Priority Data
Sep. 30, 2013 (JP) 2013-203058

(51) Int. Cl. B60J 1/17; B60J 10/04

(52) U.S. Cl. CPC B60J 1/17; B60J 10/04
USPC 49/440

(57) ABSTRACT

A glass run exhibiting excellent durability and a favorable design, which is formed by linearly connecting an outer sub-seal lip of a rear vertical side part of the glass run to a root of an outer seal lip of an upper side part thereof in a corner part. In the corner part of the glass run for automobile, an outer side wall, an inner side wall, a bottom wall, an outer seal lip and an inner seal lip are connected to corresponding parts of an upper side and a vertical side thereof by molding. In the upper side of the corner part, the outer side wall continuously extends from the upper side part of the glass run to an end of the corner part, an outer sub-seal lip of the vertical side of the corner part is linearly connected to a root of the outer seal lip of the upper side extended, and a thick joint is formed on an interior side of a connected part between the outer sub-seal lip and root of the outer seal lip of the upper side of the corner part so as to cover the connected part.

### CROSS-REFERENCE TO RELATED APPLICATION

This application is related to and claims priority from Japanese patent Application No.2013-203058 incorporated herein by reference.

### BACKGROUND OF THE INVENTION

1. Field of the Invention

The present invention relates to a glass run adapted to be attached to an inner periphery of a door frame of an automobile door for guiding a door glass as it is raised and lowered.

2. Description of Related Art

As shown in FIG. 1, a glass run 10 is attached to an inner periphery of a door frame 12 of an automobile door 14 for guiding a door glass 16 as it is raised and lowered. A conventional attaching structure of the glass run 10 is shown in FIG. 2. FIG. 2 is a cross-sectional view taken along line A-A in FIG. 1, which shows the attaching relationship of the glass run 10 and weather strips in the door frame 12 and a door opening portion 18.

As shown in FIG. 2, conventionally, the glass run 10 is fitted in a channel 20 of the door frame 12 to guide the door glass 16 upwardly and downwardly, and provide a seal between the door glass 16 and the door frame 12. And, as shown in FIG. 1, in the glass run 10, straight parts 22 formed by extrusion for attachment to an upper side, a front vertical side and a rear vertical side of the door frame 12, are connected to each other with corner parts 24 formed by molding in conformity with the configuration of the door frame 12.

On the other hand, as shown in FIG. 2, a seal between the automobile door 14 and an automobile body is provided with a door weather strip 26 attached to an outer periphery of the door frame 12, and/or an opening trim weather strip 28 attached to a flange provided in the door opening portion 18 of the automobile body. When the automobile door 14 is closed, a tubular seal portion of the opening trim weather strip 28 contacts and seals an interior side surface of a protrusion of an inner panel 30 of the door frame 12.

As shown in FIG. 2, the glass run 10 includes an outer side wall 32, an inner side wall 34 and a bottom wall 36, and has a generally U-shaped cross-section. An outer seal lip 38 is provided to extend from an open end of the outer side wall 32 towards an interior of the glass run 10. And an inner seal lip 40 is provided to extend from an open end of the inner side wall 34 towards the interior of the glass run 10. An outer cover lip 42 extends from the open end of the outer side wall 32 toward the bottom wall 36 along an exterior surface of the outer side wall 32, and an inner cover lip 43 extends from the open end of the inner side wall 34 toward the bottom wall 36 along an exterior surface of the inner side wall 34. The outer cover lip 42 and the inner cover lip 43 may be formed short according to the configuration of the door frame 12.

And, as shown in FIG. 1, in a corner 44 of the door frame 12, the upper side of the door frame 12 abuts the rear vertical side thereof, and they are joined to each other, and an upper side and a rear vertical side of the channel 20 are joined to each other, similarly. As a result, the corner 44 of the door frame 12 is formed into an acute angle, and the corner part 24 of the glass run 10 is formed into an acute angle by molding in conformity with the configuration of the channel 20.

As shown in FIG. 3, where a flange end of the door frame 12 is covered with a glass run 46, in a corner part 48 connecting an upper side part 50 to a rear vertical side part 52, the upper side of the door frame 12 is covered with a bottom wall 54 of a trim portion 56 of the glass run 46 such that exterior surfaces of the bottom wall 54 and an outer side wall 58 of a glass run portion 60 are visible from an automobile exterior side. In the corner part 48, the bottom wall 54 and the outer side wall 58 of the glass run 46 extend continuously from the upper side part 50 towards an end of the corner part 48 (see Japanese patent application laid-open No. 2002-46476, for example).

In addition, in the corner part 48 connecting the upper side part 50 to the rear vertical side part 52, the outer side wall 58, an outer seal lip 62, an inner side wall 64, an inner seal lip 66 and a bottom wall 68, each extending from the rear vertical side part 52, are respectively connected to those of the upper side part 50.

As shown in FIG. 3, in a connected part 70, the outer seal lip 62 of the rear vertical side part 52 is linearly connected to a root of the outer seal lip 62 in an extension portion of the upper side part 50 such that the bottom wall 54 and the outer side wall 58 of the upper side part 50 of the glass run 46 define a molding part of which design continues laterally.

And, as shown in FIG. 4, where an outer side wall 72 of a rear vertical side part 74 of a glass run 76 has an outer seal lip 78 and an outer sub-seal lip 80, an outer side wall 72 and an outer seal lip 78 of an upper side part of the glass run 76 are respectively connected to those of the rear vertical side part 74 in a corner part 86. (see Japanese patent application laid-open No. 2001-239840, for example).

In this case, the outer sub-seal lip 80 is connected to a root of the outer seal lip 78 of the upper side part in the corner part 86 formed into an arc shape.

However, where the outer sub-seal lip 80 of the rear vertical side part 74 is connected to the root of the outer seal lip 78 of the upper side part linearly in the corner part 86 such that design of the upper side of the door frame 12 continues laterally, as shown in FIG. 3, a tip end of the outer sub-seal lip 80, which is thin, may be cracked or broken during assembling and using of the door glass 76.

### SUMMARY OF THE INVENTION

It is an object of the present invention to provide a glass run exhibiting excellent durability and a favorable design, which is adapted to be attached to a corner of a door frame of an automobile door, by linearly connecting an outer sub-seal lip of a rear vertical side part of the glass run to a root of an outer seal lip of an upper side part thereof.

In order to achieve the above-described object, according to a first aspect of the present invention, in a glass run attached to an inner periphery of a door frame of a door of an automobile for guiding a door glass as it is raised and lowered, and having straight parts formed by extrusion, and corner parts formed by molding, which are adapted to contact corner pieces attached to corners of the door frame, the straight parts include an upper side part for attachment to an upper side of the door frame, a front vertical side part for attachment to a front vertical side of the door frame and a rear vertical side part for attachment to a rear vertical side of the door frame, the upper side part integrally includes a trim portion, and has an outer side wall, an inner side wall and a bottom wall defining a generally U-shaped cross-section, an outer seal lip and an inner seal lip respectively extend from ends of the outer side wall and the inner side wall obliquely inwardly to seal an exterior surface and an interior surface of an end edge of the door glass,

the front vertical side part or the rear vertical side part has an outer side wall, an inner side wall and a bottom wall defining a generally U-shaped cross-section, an outer seal lip extends from an end of the outer side wall obliquely inwardly, an outer extension wall is formed from the end of the outer side wall in the extension direction thereof, an outer sub-seal lip is formed from an end of the outer extension wall obliquely outwardly, an inner seal lip extends from an end of the inner side wall obliquely inwardly, the outer seal lip, the outer sub-seal lip, and the inner seal lip seal the exterior surface and the interior surface of the end edge of the door glass, in the corner part connecting the upper side part to the front vertical side part or the rear vertical side part, the outer side wall, the inner side wall, the bottom wall, the outer seal lip and the inner seal lip of an upper side of the corner part are connected to corresponding members of an vertical side of the corner part by molding, the outer side wall of the upper side of the corner part continuously extends from the upper side part of the glass run to an end of the corner part, the outer sub-seal lip of the front vertical side of the vertical side of the corner part is linearly connected to a root of the outer seal lip of the upper side of the corner part extended, and a thick joint is formed on an interior side of a connected part between the outer sub-seal lip and the outer seal lip of the upper side of the corner part so as to cover the connected part.

With the arrangement of the first aspect of the present invention, the straight parts of the glass run include an upper side part for attachment to an upper side of the door frame, a front vertical side part for attachment to a front vertical side of the door frame and a rear vertical side part for attachment to a rear vertical side of the door frame. As a result, each of the straight parts can have an appropriate cross-sectional shape.

The upper side part of the glass run integrally includes a trim portion so that the trim portion holds a flange provided along a tip end edge of the door frame and can define an integrally continuous molding surface with a bottom wall of the trim portion and the outer side wall, which is favorable in design.

The upper side part of the glass run includes an outer side wall, an inner side wall and a bottom wall defining a generally U-shaped cross-section, and an outer seal lip and an inner seal lip respectively extend from ends of the outer side wall and the inner side wall obliquely inwardly to seal an exterior surface and an interior surface of an upper end edge of the door glass.

As a result, when the door is closed, the upper end edge of the door glass can be accommodated in an interior of the upper side part including an outer side wall, an inner side wall and a bottom wall defining a generally U-shaped cross-section so that when the door glass is raised, the upper end edge of the door glass can be securely held. Since the outer seal lip and the inner seal lip seal the exterior surface and the interior surface of the upper edge of the door glass, when the door glass is raised, both seal lips contact the door glass to provide a seal between the upper side of the door frame and the door glass.

The rear vertical side part or the front vertical side part includes an outer side wall, an inner side wall and a bottom wall defining a generally U-shaped cross-section, an outer seal lip extends from an end of the outer side wall obliquely inwardly, an outer extension wall is formed from the end of the outer side wall in the extension direction thereof, an outer sub-seal lip is formed from an end of the outer extension wall obliquely outwardly, an inner seal lip extends from an end of the inner side wall obliquely inwardly, and the outer seal lip, the outer sub-seal lip, and the inner seal lip seal the exterior surface and the interior surface of an end edge of the door glass.

Therefore, when the door glass is raised and lowered, the end edge of the door glass can be accommodated in an interior of the vertical side part having a generally U-shaped cross-section so that the door glass can be securely held therein. Since the outer seal lip, the outer sub-seal lip and the inner seal lip seal the exterior surface and the interior surface of the end edge of the door glass, the seal lips contact the door glass according to the sliding of the door glass so that the outer seal lip, the outer sub-seal lip and the inner seal lip can provide a seal between the door frame and the door glass.

In the corner part connecting the upper side part to the front vertical side part or the rear vertical side part, the outer side wall, the inner side wall, the bottom wall, the outer seal lip and the inner seal lip of the upper side of the corner part are connected to corresponding members of the vertical side of the corner part by molding. Therefore, in the corner part, the side walls and the seal lips are continuously formed, the sealing properties of the corner part can be ensured.

The outer side wall on the upper side of the corner part continuously extends from the upper side part to an end of the corner part so that the corner part can have a design surface laterally continuing from the upper side part to the end of the corner part, which is favorable in design.

The outer sub-seal lip of the vertical side of the corner part is linearly connected to a root of the outer seal lip of the upper side extended, and a thick joint is formed on an interior side of a connected part between the outer sub-seal lip and the root of the outer seal lip of the upper side of the corner part so as to cover the connected part. With this arrangement, an acute angled design surface can be provided in the exterior surface of the corner part, which is favorable in design. In addition, the strength of the connected part between the outer sub-seal lip and the root of the outer seal lip of the upper side of the corner part can be improved so that the connected part can be prevented from being damaged during assembling and using of the glass run.

According to a second aspect of the present invention, a surface of the thick joint is formed into a curved concave shape or a linear shape.

In the second aspect of the present invention, the surface of the thick joint is formed into a curved concave shape or a linear shape so that when an external force is applied to the thick joint, there is no area to which stress is concentrated, thereby preventing the connected part from being damaged during assembling and using of the glass run.

According to a third aspect of the present invention, the thick joint is formed in an end of the outer sub-seal lip.

In the third aspect of the present invention, the thick joint is formed in the end of the outer sub-seal lip. As a result, an area to which stress is most applied during assembling and using of the glass run can be protected, thereby preventing generation of sinks, etc. in the connected part.

According to a fourth aspect of the present invention, an end of the outer sub-seal lip is connected to the outer seal lip in the position of an exterior surface of the door glass in a fully closed state thereof.

In the fourth aspect of the present invention, the end of the outer sub-seal lip is connected to the outer seal lip in the position of an exterior surface of the door glass in a fully closed state thereof. Since the end of the outer sub-seal lip is connected to the outer seal lip of the upper side part of the glass run in the position of an exterior surface of the door glass in a fully closed state thereof, when the door glass is fully closed, there does not generate any gap between the end of the outer sub-seal lip (that is near the connected part) and the exterior surface of the door glass. In addition, there is no flexure margin so that no distortion is generated in the connected part, and generation of cracks is restrained therein.

The outer sub-seal lip of the vertical side of the glass run is linearly connected to a root of the outer seal lip of the upper side extended, and a thick joint is formed on an interior side of a connected part between the outer sub-seal lip and the root of the outer seal lip of the upper side so as to cover the connected part, and as a result, an acute angled design surface can be provided in the exterior surface of the corner part, which is favorable in design. In addition, the strength of the connected part between the outer sub-seal lip and the root of the outer seal lip of the upper side can be improved so that the connected part can be prevented from being damaged during assembling and using of the glass run.

Other objects, features, and characteristics of the present invention will become apparent upon the consideration of the following description and the appended claims with reference to the accompanying drawings, all of which form a part of this specification.

### BRIEF DESCRIPTION OF THE DRAWINGS

FIG. 1 is a side view of a motor vehicle;

FIG. 2 is a diagram showing an attachment of a conventional glass run to a door frame;

FIG. 3 is a front view of a corner part of another conventional glass run;

FIG. 4 is a partially cut away front view of a corner part of still another conventional glass run;

FIG. 5 is a cross-sectional view of an upper side part in one embodiment of a glass run in accordance with the present invention;

FIG. 6 is a cross-sectional view of a rear vertical side part in one embodiment of a glass run in accordance with the present invention;

FIG. 7 is a front view of a corner part in one embodiment of a glass run in accordance with the present invention;

FIG. 8 is a partially cut away perspective view of a corner part in one embodiment of a glass run in accordance with the present invention; and

FIG. 9 is an enlarged view of a rear surface of a connected part of an outer sub-seal lip of a rear vertical section to an outer seal lip of an upper side of a corner part in one embodiment of a glass run in accordance with the present invention.

### DETAILED DESCRIPTION OF THE PREFERRED EMBODIMENTS

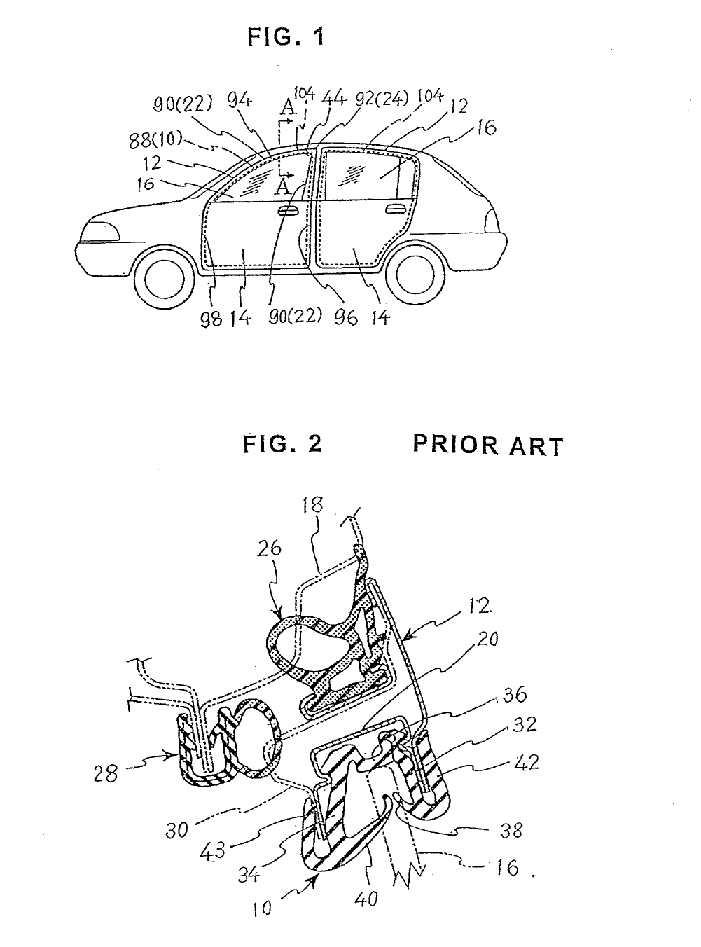

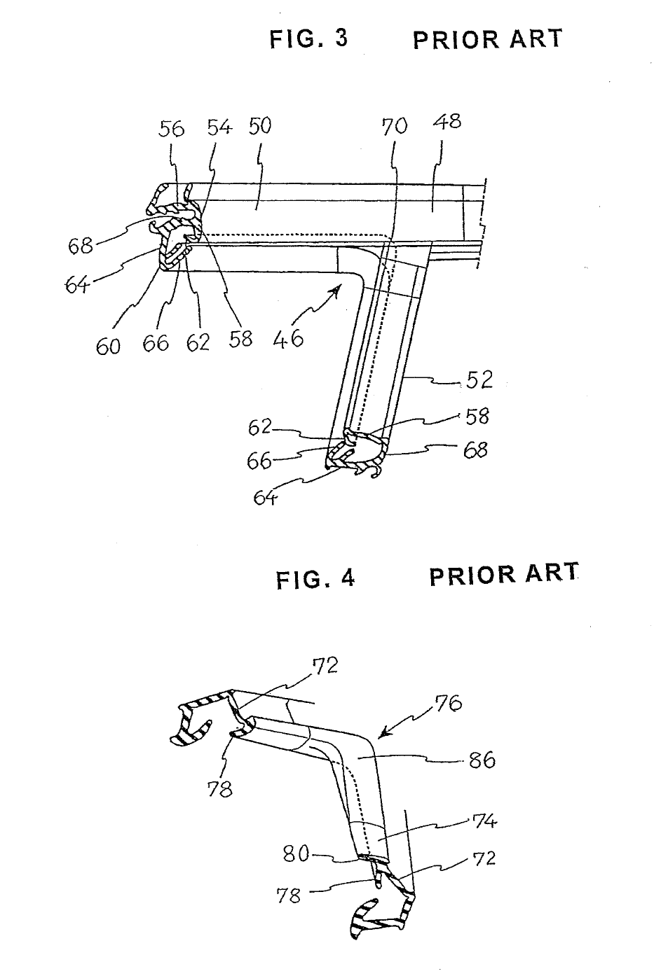

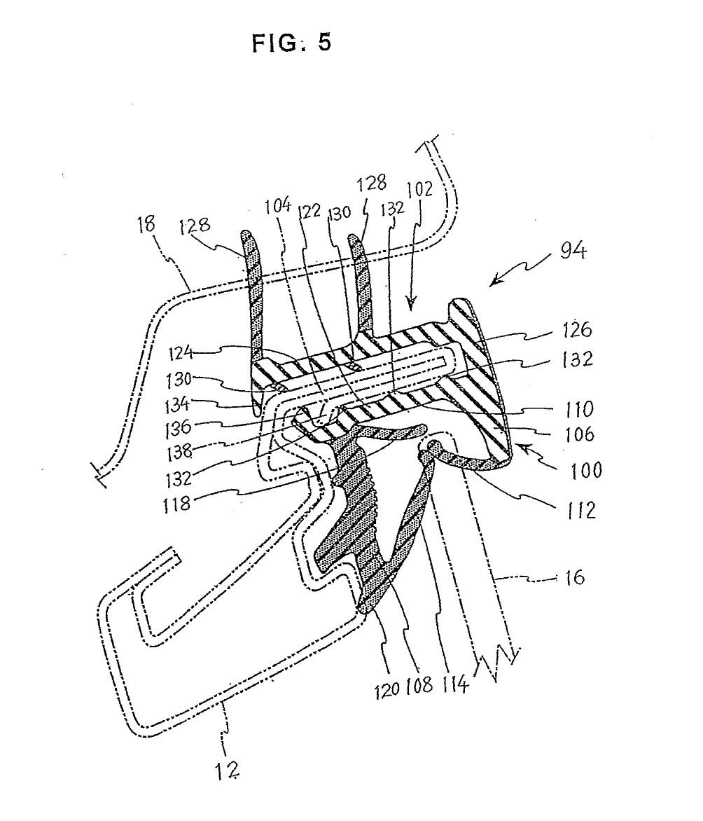

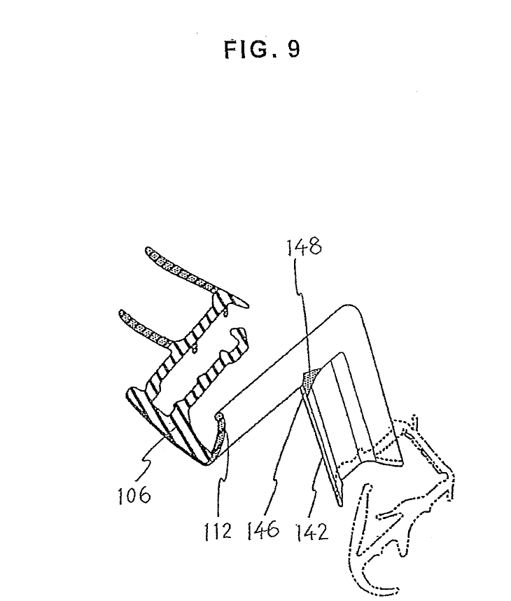

One embodiment of the present invention will be explained with reference to FIG. 1, and FIG. 5 through FIG. 9.

FIG. 1 is a side view of an automobile.

As shown in FIG. 1, a door frame 12 is provided in an upper part of an automobile door 14, and a door glass 16 is attached thereto so as to be raised and lowered therealong. The door glass 16 and a glass run 88 are provided in a door glass opening defined around an inner periphery of the door frame 12, and the glass run 88 guides the door glass 16 as it is raised and lowered, and provides a seal between the door glass 16 and the door frame 12.

The glass run 88 includes straight parts 90, each having an approximately linear shape and being formed by extrusion, and corner parts 92, each being formed by molding to connect the straight parts 90 to each other, and attached to a corner 44 of the door frame 12.

The straight parts 90 include an upper side part 94 for attachment to an upper side of the door frame 12, a rear vertical side part 96 for attachment to a rear vertical side of the door frame 12 and a front vertical side part 98 for attachment to a front vertical side of the door frame 12. On the front side of the automobile door 14, the upper side of the door frame 12 is formed obliquely downwardly towards a front end of an automobile so that the upper side part 94 makes an obtuse angle with the front vertical side part 98 of the glass run 88. The door frame 12 along with a door molding defines a channel having an approximately U-shaped cross-section for attaching the glass run 88.

These straight parts 90 of the glass run 88 are connected in corners by molding in conformity with the configuration of the door frame 12 to define a corner part 92 for attachment to the corner 44 of the door frame 12.

The present invention will be explained with reference to a rear corner part 92 of a front door 14, but the present invention can be also applied to a front corner of a rear door.

As shown in FIG. 5, the upper side part 94 of the glass run 88 includes a glass run portion 100 adapted to be attached along an inner periphery of the door frame 12 and a trim portion 102 adapted to be attached to a flange 104 that is provided along an end of the door frame 12.

The glass run portion 100 has a main body with a generally U-shaped cross-section, which includes an outer side wall 106, an inner side wall 108 and a bottom wall 110. An outer seal lip 112 and an inner seal lip 114 respectively extend from ends of the outer side wall 106 and the inner side wall 108 obliquely in an interior space of the main body. Therefore, an end edge of the door glass 16 slides in the interior space of the main body of the glass run portion 100, which includes the outer side wall 106, the inner side wall 108 and the bottom wall 110, thereby holding the door glass 16.

The inner side wall 108, the outer seal lip 112 and the inner seal lip 114 of the glass run portion 100 are composed of a soft material. It is preferable to use a thermoplastic olefin elastomer as the soft material.

The outer side wall 106 and the bottom wall 110 are composed of a hard material.

The outer side wall 106 is formed so as to have a thick root and gradually decrease its thickness to its tip end. In addition, the outer side wall 106 is formed to define a curving interior surface. As a result, the outer side wall 106 exhibits great rigidity so that if the door frame 12 greatly curves, deformations such as wrinkles, waving, etc. of the outer side wall 106 can be prevented. And if the door glass 16 is shifted outwardly, the outer side wall 106 can hold the end edge of the door glass 16 to prevent the door glass 16 from coming off the glass run portion 100.

It is preferable to increase the width and the thickness of both the inner side wall 108 and the inner seal lip 114, as compared with those of the outer side wall 106 and the outer seal lip 112. In this case, when the door glass 16 is raised and inserted in the interior space of the glass run 88, the door glass 16 can be shifted outwardly to reduce level difference in the exterior surface of the door 14, thereby improving the appearance therearound, and restraining the generation of wind noises. In addition, the inner side wall 108 can be securely attached to an attaching surface of the door frame 12.

A bottom lip 118 can be formed on an interior side of the bottom wall 110 so as to project from a joint between the inner side wall 108 and the bottom wall 110. When the door glass 16 is raised, the bottom lip 118 contacts an end edge of the door glass 16 to absorb shocks against the bottom wall 110.

The inner side wall 108, the outer seal lip 112 and the inner seal lip 114 along with an inner cover lip 120 of the glass run portion 100 are composed of a soft material. Therefore, the outer seal lip 112 and the inner seal lip 114 can seal the end edge of the door glass 16. In addition, the inner side wall 108 flexibly bends so that where the door frame 12 has a curved shape, the glass run portion 100 can be readily attached to the door frame 12.

Next, the trim portion 102 will be explained. The trim portion 102 has a generally U-shaped cross-section defined with a side wall 122 adapted to be joined to the bottom wall 110 of the glass run portion 100, a side wall 124 for facing the door opening portion 18, and a bottom wall 126.

The flange 104 of the door frame 12 is inserted into an interior space of the trim portion 102, and held therein, whereby the glass run 88 is attached to the door frame 12. In the present embodiment, the bottom wall 110 of the glass run portion 100 and the side wall 122 of the trim portion 102 are integrally formed as a single member composed of the same material.

Two outer seal lips 128 project from an exterior surface of the side wall 124 of the trim portion 102, which faces the door opening portion 18. As shown in FIG. 5, when the door 14 is closed, the two outer seal lips 128 contact the door opening portion 18 to provide a double seal between the door opening portion 18 and the door frame 12.

Two inner seal lips 130 are formed on an interior surface of the side wall 124 of the trim portion 102, and three holding ridges 132 are formed on an interior surface of the side wall 122 of the trim portion 102. As shown in FIG. 5, when the flange 104 of the door frame 12 is inserted into the interior space of the trim portion 102, one side surface of the flange 104 can be held with the inner seal lips 130, whereas the other side surface of the flange 104 can be held with the holding ridges 132. In addition, the trim portion 102 can be stably attached to the flange 104 of the door frame 12.

A cover lip 134 is formed on an interior surface of an end of the side wall 124 of the trim portion 102. As shown in FIG. 5, when the flange 104 of the door frame 12 is inserted into the interior space of the trim portion 102 the cover lip 134 contacts a bending base of the flange 104 to prevent the trim portion 102 from coming off the flange 104.

An engaging lip 136 is formed along an end of the side wall 122 of the trim portion 102 inwardly thereof. When the flange 104 of the door frame 12 is inserted into the interior space of the trim portion 102, the engaging lip 136 engages with a hook 138 of the flange 104 so that when a side visor is bonded to the trim portion 102, the trim portion 102 hardly comes off the flange 104.

The side walls 122 and 124, the bottom wall 126, the engaging lip 136, the cover lip 134 and the holding ridges 132 of the trim portion 102 are composed of a hard material, whereas the outer seal lips 128 and the inner seal lips 130 of the trim portion 102 are composed of a soft material. The trim portion 102 thus arranged is simultaneously formed by extrusion of the hard material and the soft material. As described above, the outer side wall 106 of the glass run portion 100 is composed of a hard material so that the rigidity of a bonding area of a side visor can be increased.

With this arrangement, a main body of the trim portion 102 can exhibit high rigidity so as to hold the flange 104, the outer seal lips 128 can flexibly contact and seal the door opening portion 18, and the inner seal lips 130 can flexibly contact and seal the flange 104.

Since the engaging lip 136 and the cover lips 134 of the trim portion 102 are composed of a hard material, the trim portion 102 can be strongly engaged with the flange 104.

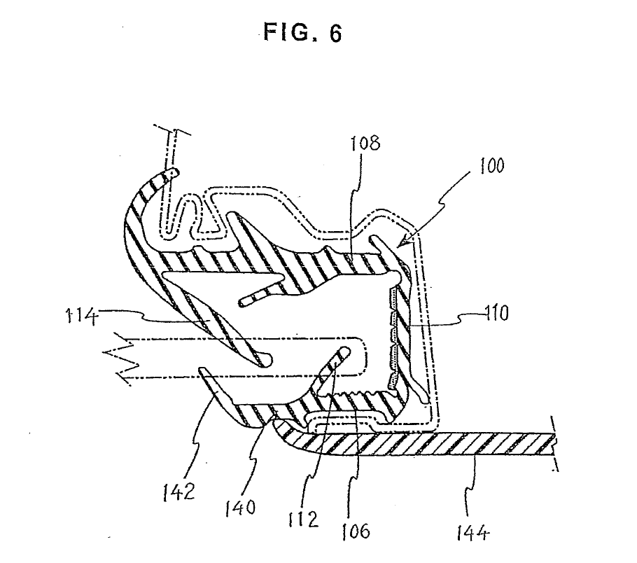

Next, the cross-sectional shape of the rear vertical side part 96 will be explained with reference to FIG. 6. The front vertical side part 98 has the cross-sectional shape similar to that of the rear vertical side part 96. The rear vertical side part 96 has only a glass run portion 100 for attachment to an inner periphery of the door frame 12, but does not have a trim portion. The cross-sectional shape of the glass run portion 100 is similar to that of the upper side part 94 of the glass run 88, and has a main body with a generally U-shaped cross-section, which includes an outer side wall 106, an inner side wall 108 and a bottom wall 110. An outer seal lip 112 and an inner seal lip 114 respectively extend from ends of the outer side wall 106 and the inner side wall 108 obliquely in an interior space of the main body. Therefore, an end edge of the door glass 16 slides in the interior space of the main body of the glass run portion 100, which includes the outer side wall 106, the inner side wall 108 and the bottom wall 110, whereby the door glass 16 can be held with the glass run portion 100.

As is different from the upper side part 94, an outer extension wall 140 is formed so as extend from the outer side wall 106 in the extension direction thereof, and an outer sub-seal lip 142 is formed so as to project from an end of the outer extension wall 140 obliquely outwardly. Therefore, the exterior side surface of the door glass 16 can be sealed doubly with the outer seal lip 112 and the outer sub-seal lip 142.

An end of a garnish 144 contacts an exterior surface of the outer extension wall 140.

The inner side wall 108, the outer seal lip 112, and the inner seal lip 114 of the glass run portion 100 are composed of a soft material. It is preferable to use olefin thermoplastic elastomer as the soft material.

Next, the corner part 92 of the glass run 88 will be explained.

As shown in FIG. 1, in a rear corner 44 of the automobile door 14, the upper side of the door frame 12 is formed approximately horizontally, whereas the rear vertical side of the door frame 12 is formed slightly obliquely rearwards. The upper side of the door frame 12 abuts the rear vertical side thereof, and they are joined to each other so as to make an acute angle with each other. And, as shown in FIG. 1, the corner part 92 of the glass run 88 is attached to the rear corner 44 of the door frame 12.

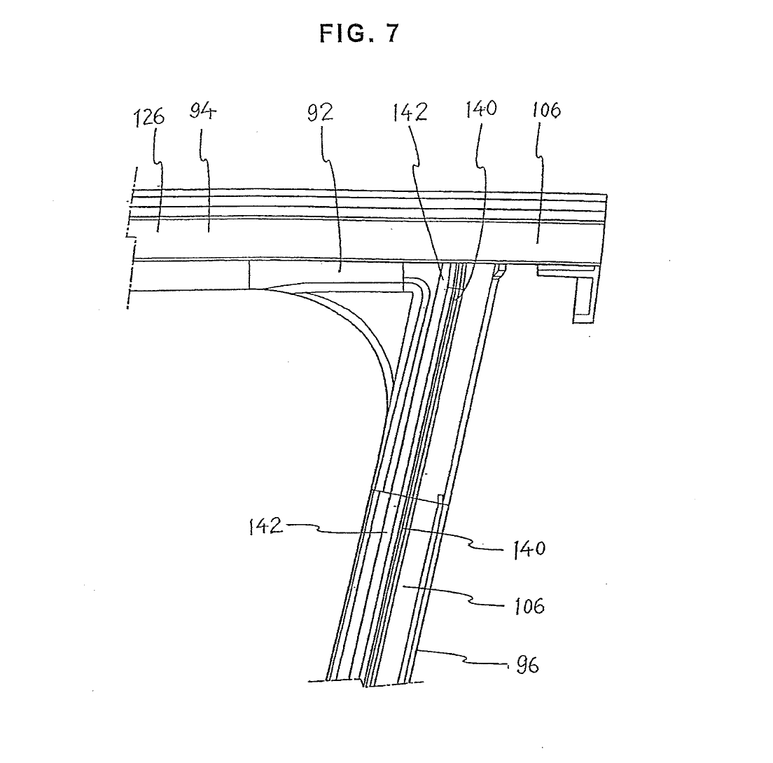

As shown in FIG. 7, the corner part 92 connects the upper side part 94 to the rear vertical side part 96, and is formed by molding in conformity with the configuration of the corner 44 of the door frame 12. The corner part 92 connects the upper side part 94 to the rear vertical side part 96 with heat caused by molding.

The corner part 92 between the upper side part 94 and the rear vertical side part 96 will be explained, but a corner part between the upper side part 94 and the front vertical side part 98 has a similar construction. As shown in FIG. 7, an upper side of the corner part 92 of the glass run 88, which is adapted to be connected to the upper side part 94, has a similar cross-sectional shape to that of the upper side part 94, and an outer side surface of the corner part 92, which is continuously defined with the outer side wall 106 and the bottom wall 126, is linearly extended to an end of the door frame 12. As a result, in the corner part 92, the outer side wall 106 and an exterior surface of the bottom wall 126 are extended continuously with the upper side part 94 without any break, and consequently, a laterally continuous design surface is obtained, which is favorable in design.

A vertical side of the corner part 92 of the glass run 88, which is adapted to be connected to the rear vertical side part 96, has a similar cross-sectional shape to that of the rear vertical side part 96, and the outer side wall 106, the inner side wall 108, the bottom wall 110, the outer seal lip 112 and the inner seal lip 114 of the vertical side of the corner part 92 are connected to corresponding parts of the upper side thereof.

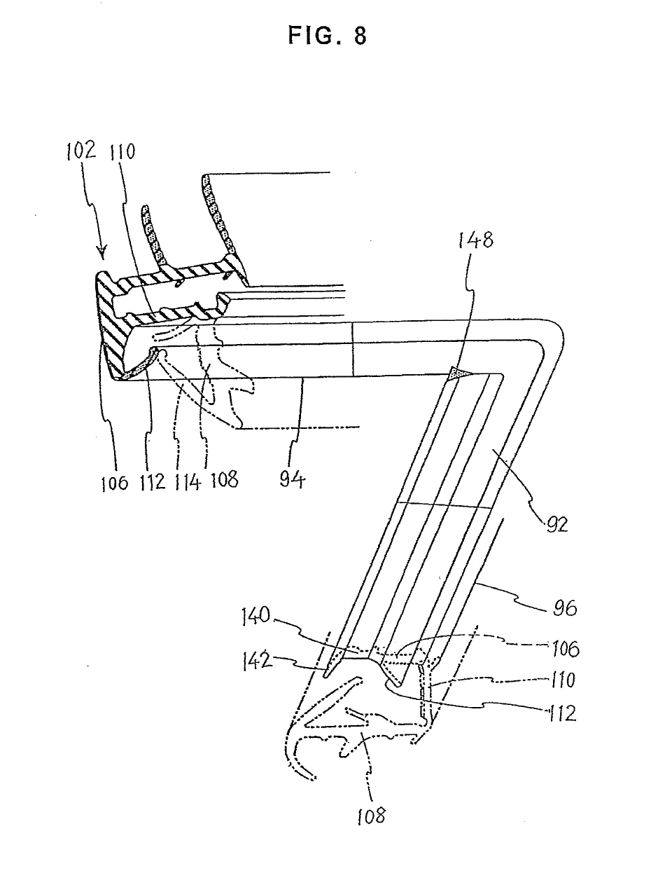

As shown in FIG. 8, the outer extension wall 140 and the outer sub-seal lip 142 are linearly connected to a root of the outer seal lip 112 of the upper side of the corner part 92.

An upper end of the outer sub-seal lip 142 is connected to the root of the outer seal lip 112 of the upper side of the corner part 92 in the position slightly near an end of the outer seal lip 112 thereof such that when the door glass 16 is raised, an outer end edge of the door glass 16 contacts the outer sub-seal lip 142. With this arrangement, when the door glass 16 is raised, the outer end edge of the door glass 16 securely contacts the root of the outer seal lip 112 of the upper side of the corner part 92 and enters the interior of the glass run portion 100 along a surface of the outer seal lip 112.

A thick joint 146 is formed on the interior side of a connected part 148 between the outer sub-seal lip 142 and the outer seal lip 112 of the upper side of the corner part 92 so as to cover the connected part 148. Therefore, the thick joint 146 can improve the strength of the connected part 148 between the outer sub-seal lip 142 and the outer seal lip 112 of the upper side of the corner part 92 so as to prevent the connected part 148 from being broken during assembling and using of the glass run 88.

It is preferable to form a surface of the thick joint 146 into a curved concave shape or a linear shape. With this arrangement, when an external force is applied to the thick joint 146, there is no area to which stress is concentrated, thereby preventing the connected part 148 from being broken during assembling and using of the glass run 88.

In addition, where the thick joint 146 is formed in an end of the outer sub-seal lip 142, the area to which the external force is most applied during assembling and using of the glass run 88 is protected to prevent generation of sinks, etc. in the connected part 148.

When the glass run 88 is formed, a synthetic rubber, a thermoplastic elastomer or a soft synthetic resin is used as the materials of the straight parts 90 and the corner parts 92. Examples of the synthetic rubber include an EPDM rubber, examples of the thermoplastic elastomer include an olefin elastomer, and examples of the soft synthetic resin include a soft vinyl chloride. Where the EPDM rubber and olefin elastomer are used, they are similar materials so that the glass run 88 can be readily recycled.

The straight parts 90 are formed into a linear shape by means of an extruder.

In the case of the synthetic rubber, after extrusion, it is transferred into a vulcanization chamber, and heated by hot wind and high frequency wave, etc. to be vulcanized. In the case of thermoplastic elastomer and soft synthetic resin, a cooling process is performed for solidification. Then, after vulcanization or solidification, a cutting process is performed into predetermined lengths. As a result, extruded parts are obtained.

The molded parts adapted to form the corner parts 92 are formed by cutting the extruded members adapted to form the straight parts 90 to predetermined dimensions, holding ends of the extruded members thus cut with a mold adapted to mold the molded parts, and injecting a molding material adapted to form the molded parts into a cavity of the mold. The cross-sectional shape of the molded part is approximately identical to that of the extruded part. It is preferable to use the molding material of the same kind with that of the material used to form the extruded part. In the case of the thermoplastic elastomer and the soft synthetic resin, the molding material injected into the mold is in the molten state, the extruded part and the molded part are integrally fused to each other with heat and pressure of the molding material.

While the invention has been described in connection with what are considered to be the preferred embodiments, it is to be understood that the invention is not limited to the disclosed embodiments, but, on the contrary, is intended to cover various modifications and equivalent arrangements included within the spirit and scope of the appended claims.

What is claimed is:

1. A glass run for an automobile, which is adapted to be attached to an inner periphery of a door frame of a door of an automobile for guiding a door glass as it is raised and lowered, comprising:
straight parts formed by extrusion, and corner parts formed by molding for contacting corner pieces attached to corners of the door frame, said straight parts including an upper side part for attachment to an upper side of the door frame, a front vertical side part for attachment to a front vertical side of the door frame and a rear vertical side part for attachment to a rear vertical side of the door frame, wherein
said upper side part integrally includes a trim portion, and has an outer side wall, an inner side wall and a bottom wall defining a generally U-shaped cross-section such that an outer seal lip and an inner seal lip respectively extend from ends of said outer side wall and said inner side wall obliquely inwardly to seal an exterior surface and an interior surface of an end edge of the door glass,
one of said front vertical side part and said rear vertical side part has an outer side wall, an inner side wall and a bottom wall defining a generally U-shaped cross-section such that an outer seal lip extends from an end of said outer side wall obliquely inwardly, an outer extension wall is formed from said end of said outer side wall in the extension direction thereof, an outer sub-seal lip is formed from an end of said outer extension wall obliquely outwardly, an inner seal lip extends from an end of said inner side wall obliquely inwardly, and said outer seal lip, said outer sub-seal lip and said inner seal lip seal the exterior surface and the interior surface of the end edge of the door glass, and
in said corner part connecting said upper side part to one of said front vertical side part and said rear vertical side part, said outer side walls, said inner side walls, said bottom walls, said outer seal lips and said inner seal lips of said upper side part and said one of said front vertical side part and said rear vertical side are connected to corresponding parts of an upper side and a vertical side of said corner part by molding, said outer side wall of said upper side of said corner part continuously extends from said upper side part to an end of said corner part, said outer sub-seal lip of said vertical side of said corner part is linearly connected to a root of said outer seal lip of said upper side extended, and a thick joint is formed on an interior side of a connected part between said outer sub-seal lip and said root of said outer seal lip of said upper side of said corner part so as to cover said connected part.

2. The glass run as claimed in claim 1, wherein a surface of said thick joint is formed into one of a curved concave shape and a linear shape.

3. The glass run as claimed in claim 1, wherein said thick joint is formed in an end of said outer sub-seal lip.

4. The glass run as claimed in claim 1, wherein an end of said outer sub-seal lip is connected to said outer seal lip in the position of an exterior surface of the door glass in a fully closed state thereof.
